(19) United States
(12) Patent Application Publication
(10) Pub. No.: US 2025/0048190 A1
(43) Pub. Date: Feb. 6, 2025

(54) CONDITIONAL HANDOVER CONFIGURATION METHOD, TERMINAL, AND NETWORK SIDE DEVICE

(71) Applicant: VIVO MOBILE COMMUNICATION CO., LTD., Dongguan (CN)

(72) Inventors: Xuanbing LIU, Dongguan (CN); Wei BAO, Dongguan (CN)

(73) Assignee: VIVO MOBILE COMMUNICATION CO., LTD., Dongguan (CN)

(21) Appl. No.: 18/922,335

(22) Filed: Oct. 21, 2024

Related U.S. Application Data
(63) Continuation of application No. PCT/CN2023/089146, filed on Apr. 19, 2023.

(30) Foreign Application Priority Data
Apr. 22, 2022 (CN) 202210429648.5

(51) Int. Cl. H04W 36/00

(52) U.S. Cl. CPC H04W 36/0016; H04W 36/0085

(57) ABSTRACT

This application discloses a conditional handover configuration method, a terminal, and a network side device. The method includes: a terminal receives a conditional handover message. The conditional handover message includes a configuration for at least one CHO candidate cell and a configuration for at least one CPAC candidate cell. The configuration for the CHO candidate cell is used for conditional primary cell change; the configuration for the CPAC candidate cell is used for conditional primary secondary cell addition or change and includes an execution condition. A measurement identifier indicated by the execution condition for the CPAC candidate cell is a measurement identifier of a first measurement configuration. The first measurement configuration includes one of the following: an MCG measurement configuration, an SCG measurement configuration, a target MCG measurement configuration, or a target SCG measurement configuration. The measurement identifier is associated with a measurement object and a report configuration.

### CROSS-REFERENCE TO RELATED APPLICATIONS

The application is a continuation of International Application No. PCT/CN 2023/089146, filed on Apr. 19, 2023, which claims priority to Chinese Patent Application No. 202210429648.5, filed on Apr. 22, 2022. The entire contents of each of the above-referenced applications are expressly incorporated herein by reference.

### TECHNICAL FIELD

This application pertains to the field of communications, and in particular, to a conditional handover configuration method, a terminal, and a network side device.

### BACKGROUND

Dual Connectivity (DC) is a resource that provides two network nodes (access network elements) for a terminal. One network node is a Master Node (MN) and the other network node is a Secondary Node (SN). A Secondary Cell Group (SCG) controlled by the SN includes a Primary Secondary Cell (PSCell) and some Secondary Cells (SCell).

In a process of configuring conditional PSCell addition or change Conditional PSCell Addition or Change (CPAC), a network needs to provide a conditional reconfiguration for CPAC for the terminal, where an execution condition for a CPAC candidate cell is indicated in the CPAC conditional reconfiguration. Otherwise, the terminal cannot perform a CPAC evaluation process, that is, cannot perform PSCell addition and/or change in a process of conditional handover.

### SUMMARY

Embodiments of this application provide a conditional handover configuration method, a terminal, and a network side device.

According to a first aspect, a conditional handover configuration method is provided, and includes: A terminal receives a conditional handover message, where the conditional handover message includes a configuration for at least one Conditional Handover (CHO) candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an Master Cell Group (MCG) measurement configuration, an SCG measurement configuration, a target MCG measurement configuration, and a target SCG measurement configuration, and the measurement identifier is associated with a measurement object and a report configuration.

According to a second aspect, a conditional handover configuration method is provided, and includes: A network side device sends a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to a third aspect, a conditional handover configuration apparatus is provided, and includes: a receiving module, configured to receive a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to a fourth aspect, a conditional handover configuration apparatus is provided, and includes: a sending module, configured to send a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to a fifth aspect, a terminal is provided. The terminal includes a processor and a memory, the memory stores a program or an instruction that is executable on the processor, and the program or the instruction is executed by the processor to implement the steps of the method according to the first aspect.

According to a sixth aspect, a terminal is provided, and includes a processor and a communication interface. The communication interface is configured to receive a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to a seventh aspect, a network side device is provided. The network side device includes a processor and a memory, the memory stores a program or an instruction that is executable on the processor, and the program or the instruction is executed by the processor to implement the steps of the method according to the second aspect.

According to an eighth aspect, a network side device is provided, and includes a processor and a communication interface. The communication interface is configured to send a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to a ninth aspect, a conditional handover configuration system is provided, including a terminal and a network side device. The terminal may be configured to perform the steps of the method according to the first aspect, and the network side device may be configured to perform the steps of the method according to the second aspect.

According to a tenth aspect, a readable storage medium is provided, where the readable storage medium stores a program or an instruction, and the program or the instruction is executed by a processor to implement the steps of the method according to the first aspect or implement the steps of the method according to the second aspect.

According to an eleventh aspect, a chip is provided. The chip includes a processor and a communication interface. The communication interface is coupled to the processor, and the processor is configured to run a program or instructions to implement the steps of the method according to the first aspect or implement the steps of the method according to the second aspect.

According to a twelfth aspect, a computer program/program product is provided. The computer program/program product is stored in a storage medium, and the computer program/program product is executed by at least one processor to implement the steps of the method according to the first aspect or implement the steps of the method according to the second aspect.

In the embodiments of this application, in a process of conditional handover with CPAC, the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help the terminal evaluate the execution condition for the CPAC candidate cell according to the corresponding measurement configuration, so that primary secondary cell addition and/or change can be performed in the process of conditional handover, to improve communication system performance.

### BRIEF DESCRIPTION OF DRAWINGS

FIG. 1 is a schematic diagram of a wireless communication system according to an embodiment of this application;

FIG. 2 is a schematic flowchart of a conditional handover configuration method according to an embodiment of this application;

FIG. 3 is a schematic flowchart of a conditional handover configuration method according to an embodiment of this application;

FIG. 4 is a schematic diagram of a structure of a conditional handover configuration apparatus according to an embodiment of this application;

FIG. 5 is a schematic diagram of a structure of a conditional handover configuration apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th Generation (6G) communications system.

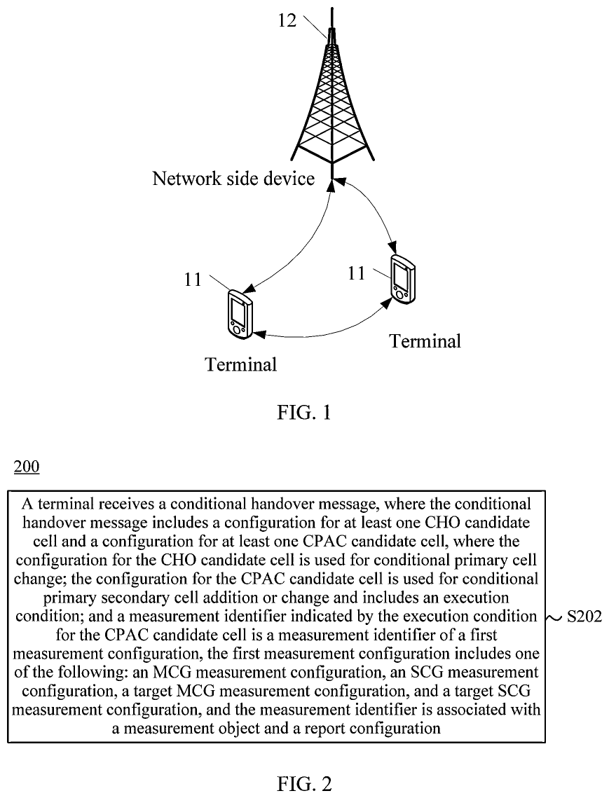

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station a Wireless Local Area Network (WLAN) access node, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. Provided that a same technical effect is achieved, the base station is not limited to a specified technical term. It should be noted that, in the embodiments of this application, only a base station in an NR system is used as an example for description, and a specific type of the base station is not limited.

The following describes in detail the conditional handover configuration method provided in the embodiments of this application through some embodiments and application scenarios thereof with reference to the accompanying drawings.

As shown in FIG. 2, an embodiment of this application provides a conditional handover configuration method 200. The method may be performed by a terminal. In other words, the method may be performed by software or hardware installed in the terminal. The method includes the following steps.

S202: The terminal receives a conditional handover message, where the conditional handover message includes a configuration for at least one CHO candidate cell and a configuration for at least one CPAC) candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: a MCG measurement configuration (measConfig), a Secondary Cell Group (SCG) measurement configuration, a target MCG measurement configuration, and a target SCG measurement configuration, and the measurement identifier is associated with a measurement object and a report configuration.

In this embodiment, the conditional handover message received by the terminal may be Radio Resource Control (RRC) reconfiguration message, or may be an RRC connection reconfiguration message.

In this embodiment, the configuration for the CPAC candidate cell may also be referred to as a conditional reconfiguration for the CPAC candidate cell. The conditional reconfiguration for the CPAC candidate cell includes the execution condition for the CPAC candidate cell. In some parts in this specification, the execution condition for the CPAC candidate cell is referred to as the execution condition for short.

In this embodiment, the execution condition for the CPAC candidate cell indicates (or includes) N (where N is a positive integer) measurement identifiers (MeasId), and each measurement identifier corresponds to one measurement event. In a case that a measurement result of the terminal on a candidate cell 1 fulfills a preset condition, the terminal triggers a measurement event. In a case that measurement events corresponding to the N measurement identifiers included in the execution condition are all triggered, the terminal initiates primary secondary cell change (PSCell Change). The measurement identifier is used by the terminal to determine a measurement configuration, and the measurement identifier may be associated with a measurement object and a report configuration. The report configuration includes a trigger condition for the measurement event, to indicate a specific preset condition (determined based on a type of the measurement event and a threshold parameter) to be fulfilled by signal quality of the candidate cell 1 for the corresponding measurement event to be triggered.

In different measurement configurations, a same measurement identifier (measurement ID) may correspond to different measurement objects. For example, in the MCG measurement configuration, a measurement object corresponding to a measurement ID1 is an F1 frequency. In the SCG measurement configuration, a measurement object corresponding to the measurement ID1 is an F2 frequency. The F1 frequency is different from the F2 frequency. Therefore, in this embodiment, in a manner of indication performed by a network side device or in a predefined (such as agreed in a protocol) manner, the terminal may consider the measurement identifier indicated by the execution condition for the CPAC candidate cell as the measurement identifier of the first measurement configuration.

In an example, the measurement identifier indicated by the execution condition for the CPAC candidate cell is a measurement identifier of the MCG measurement configuration, or in other words, the terminal measures, according to the MCG measurement configuration, a measurement object corresponding to the measurement identifier indicated by the execution condition for the CPAC candidate cell. For example, the measurement identifier corresponding to the F1 frequency is 1 in the MCG measurement configuration, the measurement identifier corresponding to the F2 frequency is also 1 in the SCG measurement configuration, and the F1 frequency is different from the F2 frequency. In a case that the measurement identifier indicated by the execution condition for the CPAC candidate cell is 1, the terminal measures, according to the MCG measurement configuration, the measurement object, namely, the F1 frequency corresponding to the measurement identifier 1, but does not measure the F2 frequency. The MCG measurement configuration is measurement on a source primary cell (Source-PCell) configuration, used to configure the terminal to measure a frequency of a neighboring cell related to a source primary cell.

In an example, the measurement identifier indicated by the execution condition for the CPAC candidate cell is a measurement identifier of the SCG measurement configuration, or in other words, the terminal measures, according to the SCG measurement configuration, a measurement object corresponding to the measurement identifier indicated by the execution condition for the CPAC candidate cell. The SCG measurement configuration is measurement on a source primary secondary cell (Source-PSCell) configuration, used to configure the terminal to measure a frequency of a neighboring cell related to a source secondary primary cell.

In an example, the measurement identifier indicated by the execution condition for the CPAC candidate cell is a measurement identifier of the target MCG (Target-MCG) measurement configuration, or in other words, the terminal measures, according to the target MCG measurement configuration, a measurement object corresponding to the measurement identifier indicated by the execution condition for the CPAC candidate cell. The target MCG measurement configuration is an MCG measurement configuration included in a conditional reconfiguration for CHO, used to configure the terminal to measure a frequency of a neighboring cell related to a target primary cell.

In an example, the measurement identifier indicated by the execution condition for the CPAC candidate cell is a measurement identifier of the target SCG (Target-SCG) measurement configuration, or in other words, the terminal measures, according to the target SCG measurement configuration, a measurement object corresponding to the measurement identifier indicated by the execution condition for the CPAC candidate cell. The target SCG measurement configuration is an SCG measurement configuration included in a conditional reconfiguration for CHO, used to configure the terminal to measure a frequency of a neighboring cell related to a target primary secondary cell.

In this embodiment, the conditional handover message may include configurations of multiple CPAC candidate cells, for example, including a configuration 1 of a CPAC candidate cell 1 and a configuration 2 of a CPAC candidate cell 2. Therefore, when the method 200 is performed, the terminal may consider measurement identifiers indicated by execution conditions of the multiple CPAC candidate cells as measurement identifiers of a same measurement configuration, for example, measurement identifiers of the MCG measurement configuration. In some embodiments, the terminal may perform determining separately. For example, the terminal considers a measurement identifier indicated by an execution condition for the CPAC candidate cell 1 as a measurement identifier of the MCG measurement configuration, and considers a measurement identifier indicated by an execution condition for the CPAC candidate cell 2 as a measurement identifier of the SCG measurement configuration, and so on.

It should be noted that, that a measurement identifier indicated by the execution condition for the CPAC candidate cell is a measurement identifier of a first measurement configuration in various embodiments of this application may also be described as follows: The measurement identifier indicated by the execution condition for the CPAC candidate cell is associated with the first measurement configuration; or may be described as follows: The terminal considers the measurement identifier indicated by the execution condition for the CPAC candidate cell as the measurement identifier of the first measurement configuration. CPAC mentioned in various embodiments of this application may include Conditional PSCell Addition (CPA) and/or Conditional PSCell Change (CPC).

According to the conditional handover configuration method provided in this embodiment of this application, in a process of conditional handover with CPAC (CHO with CPAC), the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help the terminal evaluate the execution condition for the CPAC candidate cell according to the corresponding measurement configuration, so that primary secondary cell addition and/or change can be performed in the process of conditional handover, to improve communication system performance.

To describe in detail that the measurement identifier indicated by the execution condition for the CPAC candidate cell is the measurement identifier of the first measurement configuration, the following provides detailed descriptions with reference to several specific configuration methods.

### Configuration Method 1

In the configuration method 1, the first measurement configuration includes the MCG measurement configuration, where the conditional handover message includes MCG configuration information, the MCG configuration information includes the MCG measurement configuration, and the MCG configuration information includes at least one of the following:

(1) A measurement configuration corresponding to a frequency and/or an execution condition for the at least one CPAC candidate cell.

The measurement configuration corresponding to the frequency and/or the execution condition for the at least one CPAC candidate cell includes at least one of the following: the measurement identifier; the measurement object; a conditional report configuration; and a conditional trigger configuration.

In this embodiment, the measurement configuration corresponding to the frequency and/or the execution condition for the at least one CPAC candidate cell may be included in the MCG measurement configuration.

(2) The execution condition for the at least one CPAC candidate cell.

In some embodiments, the execution condition for the at least one CPAC candidate cell includes at least one of the following: the measurement identifier; the measurement object; a measurement report configuration; a conditional trigger configuration; and a conditional measurement event.

In this embodiment, the measurement identifier indicated by the execution condition for the CPAC candidate cell is the measurement identifier of the MCG measurement configuration. For example, the measurement identifier included in the execution condition for the CPAC candidate cell is defined by the MCG measurement configuration.

(3) A conditional reconfiguration identifier of the at least one CPAC candidate cell.

(4) A conditional reconfiguration for the at least one CPAC candidate cell.

In the embodiment of the configuration method 1, at least one CPAC candidate cell is associated with a CHO candidate cell in at least one of the following:

(1) An execution condition for the at least one CPAC candidate cell is included in a conditional reconfiguration information element of the CHO candidate cell.

(2) A conditional reconfiguration information element of the at least one CPAC candidate cell is included in the conditional reconfiguration information element of the CHO candidate cell.

(3) A conditional reconfiguration identifier of the at least one CPAC candidate cell is included in the conditional reconfiguration information element of the CHO candidate cell.

(4) A conditional reconfiguration for the at least one CPAC candidate cell includes information about the CHO candidate cell. The information about the CHO candidate cell may include at least one of the following: a: a cell identifier, for example, a physical cell identifier (Physical Cell ID); b: a frequency, for example, an operating frequency or a Synchronization Signal and PBCH Block (SSB) frequency; and c: a conditional reconfiguration identifier (condreconfigid, Conditional Reconfiguration ID).

In the configuration method 1, when performing CPAC evaluation, the terminal (User Equipment (UE)) can avoid decoding RRC reconfiguration information of the CHO candidate cell to obtain CPAC-related measurement configuration information, to reduce complexity of UE measurement.

### Configuration Method 2

In the configuration method 2, the first measurement configuration includes the SCG measurement configuration, where the conditional handover message includes SCG configuration information, the SCG configuration information includes the SCG measurement configuration, and the SCG configuration information includes at least one of the following:

(1) A measurement configuration corresponding to a frequency and/or an execution condition for the at least one CPAC candidate cell.

The measurement configuration corresponding to the frequency and/or the execution condition for the at least one CPAC candidate cell includes at least one of the following: the measurement identifier; the measurement object; a conditional report configuration; and a conditional trigger configuration.

In this embodiment, the measurement configuration corresponding to the frequency and/or the execution condition for the at least one CPAC candidate cell may be included in the SCG measurement configuration.

(2) The execution condition for the at least one CPAC candidate cell.

In some embodiments, the execution condition for the at least one CPAC candidate cell includes at least one of the following: the measurement identifier; the measurement object; a measurement report configuration; a conditional trigger configuration; and a conditional measurement event.

In this embodiment, the measurement identifier indicated by the execution condition for the CPAC candidate cell is the measurement identifier of the SCG measurement configuration. For example, the measurement identifier included in the execution condition for the CPAC candidate cell is defined by the SCG measurement configuration.

(3) A conditional reconfiguration identifier of the at least one CPAC candidate cell.

(4) A conditional reconfiguration for the at least one CPAC candidate cell.

### Configuration Method 2a

In the configuration method 2a, the first measurement configuration includes the SCG measurement configuration, where the conditional handover message includes MCG configuration information and SCG configuration information, the MCG configuration information includes at least one of the following: an execution condition for the at least one CPAC candidate cell; a conditional reconfiguration identifier of the at least one CPAC candidate cell; and a conditional reconfiguration for the at least one CPAC candidate cell, and the SCG configuration information includes a measurement configuration corresponding to a frequency and/or the execution condition for the at least one CPAC candidate cell. For other details about the configuration method 2a, refer to the configuration method 2.

In the embodiments of the configuration method 2 and the configuration method 2a, at least one CPAC candidate cell is associated with a CHO candidate cell in the following manner: A conditional reconfiguration for the at least one CPAC candidate cell includes information about the CHO candidate cell. That is, the conditional reconfiguration for the CPAC candidate cell includes information about a CHO candidate cell associated with the CPAC candidate cell. The information about the CHO candidate cell may include at least one of the following: a: a cell identifier, for example, a physical cell identifier (Physical Cell ID); b: a frequency, for example, an operating frequency or a Synchronization Signal and PBCH Block (SSB) frequency; and c: a conditional reconfiguration identifier (condreconfigid, Conditional Reconfiguration ID).

In some embodiments, for the embodiments of the configuration method 1, the configuration method 2, and the configuration method 2a, the method further includes: In a case that an execution condition for one or more CPAC candidate cells in the at least one CPAC candidate cell is fulfilled, the terminal obtains, according to a first conditional reconfiguration identifier of a first CPAC candidate cell in the one or more CPAC candidate cells, conditional reconfiguration information of a target primary secondary cell corresponding to the first conditional reconfiguration identifier from RRC reconfiguration information of the CHO candidate cell.

In the configuration method 2, when performing CPAC evaluation, the UE can avoid decoding the RRC reconfiguration information of the CHO candidate cell to obtain CPAC-related measurement configuration information, to reduce complexity of UE measurement.

### Configuration Method 3

In the configuration method 3, the first measurement configuration includes the target MCG measurement configuration, where the conditional handover message includes RRC reconfiguration information of the CHO candidate cell, the RRC reconfiguration information of the CHO candidate cell includes target MCG configuration information, the target MCG configuration information includes the target MCG measurement configuration, and the target MCG configuration information includes at least one of the following:

(1) A measurement configuration corresponding to a frequency and/or an execution condition for the at least one CPAC candidate cell.

The measurement configuration corresponding to the frequency and/or the execution condition for the at least one CPAC candidate cell includes at least one of the following: the measurement identifier; the measurement object; a conditional report configuration; and a conditional trigger configuration.

In this embodiment, the measurement configuration corresponding to the frequency and/or the execution condition for the at least one CPAC candidate cell may be included in the target MCG measurement configuration in the RRC reconfiguration information of the CHO candidate cell.

(2) The execution condition for the at least one CPAC candidate cell.

In some embodiments, the execution condition for the at least one CPAC candidate cell includes at least one of the following: the measurement identifier; the measurement object; a measurement report configuration; a conditional trigger configuration; and a conditional measurement event.

In this embodiment, the measurement identifier indicated by the execution condition for the CPAC candidate cell is the measurement identifier of the target MCG measurement configuration for the CHO candidate cell.

(3) A conditional reconfiguration identifier of the at least one CPAC candidate cell.

(4) A conditional reconfiguration for the at least one CPAC candidate cell.

In the embodiment of the configuration method 3, the conditional handover message includes conditional reconfiguration information of the CHO candidate cell, and the conditional reconfiguration information includes at least one of the following CPAC information:
(1) the execution condition for the at least one CPAC candidate cell;
(2) the conditional reconfiguration identifier of the at least one CPAC candidate cell; and
(3) CPAC indication information, where the CPAC indication information indicates that the configuration for the CHO candidate cell has an accompanying conditional reconfiguration for CPAC, or indicates that the RRC reconfiguration information of the CHO candidate cell includes the conditional reconfiguration for the at least one CPAC candidate cell.

In the embodiment of the configuration method 3, the method further includes: The terminal executes at least one of the following:

(1) In a case that the RRC reconfiguration information of the CHO candidate cell includes the conditional reconfiguration for the at least one CPAC candidate cell, store the conditional reconfiguration for the at least one CPAC candidate cell into a conditional reconfiguration variable.

(2) In a case that the RRC reconfiguration information of the CHO candidate cell includes the conditional reconfiguration for the at least one CPAC candidate cell, store a measurement configuration for a candidate primary cell, a measurement configuration for a candidate primary secondary cell, or measurement configuration information related to the at least one CPAC candidate cell into a measurement configuration variable.

(3) Perform measurement based on the measurement configuration in the RRC reconfiguration information of the CHO candidate cell. That is, the terminal performs measurement configured in the RRC reconfiguration information of the CHO candidate cell.

(4) In a case that the RRC reconfiguration information of the CHO candidate cell includes the conditional reconfiguration for the at least one CPAC candidate cell, perform, based on the RRC reconfiguration information of the CHO candidate cell, measurement related to the conditional reconfiguration for the at least one CPAC candidate cell. That is, the terminal performs measurement related to a conditional reconfiguration for CPAC in the RRC reconfiguration information of the CHO candidate cell.

In the embodiment of the configuration method 3, in a case that a target primary secondary cell is configured for the CHO candidate cell, the method further includes at least one of the following:

(1) In a case that an execution condition for one or more CPAC candidate cells in the at least one CPAC candidate cell is fulfilled, the terminal uses a second CPAC candidate cell in the one or more CPAC candidate cells as a target primary secondary cell.

(2) In a case that the execution condition for each of the at least one CPAC candidate cell is not fulfilled, the terminal uses the target primary secondary cell configured for the CHO candidate cell.

In the configuration method 3, the conditional handover message include the CPAC information, to instruct the UE to decode the RRC reconfiguration information of the CHO candidate cell, which is conducive to reducing signaling message processing time of the UE and improving signaling transmission efficiency.

### Configuration Method 4

In the configuration method 4, the first measurement configuration includes the target SCG measurement configuration, where the conditional handover message includes RRC reconfiguration information of the CHO candidate cell, the RRC reconfiguration information of the CHO candidate cell includes target SCG configuration information, the target SCG configuration information include the target SCG measurement configuration, and the target SCG configuration information includes at least one of the following:

(1) A measurement configuration corresponding to a frequency and/or an execution condition for the at least one CPAC candidate cell.

The measurement configuration corresponding to the frequency and/or the execution condition for the at least one CPAC candidate cell includes at least one of the following: the measurement identifier; the measurement object; a conditional report configuration; and a conditional trigger configuration.

In this embodiment, the measurement configuration corresponding to the frequency and/or the execution condition for the at least one CPAC candidate cell may be included in the target SCG measurement configuration in the RRC reconfiguration information of the CHO candidate cell.

(2) The execution condition for the at least one CPAC candidate cell.

In some embodiments, the execution condition for the at least one CPAC candidate cell includes at least one of the following: the measurement identifier; the measurement object; a measurement report configuration; a conditional trigger configuration; and a conditional measurement event.

In this embodiment, the measurement identifier indicated by the execution condition for the CPAC candidate cell is the measurement identifier of the target SCG measurement configuration for the CHO candidate cell.

(3) A conditional reconfiguration identifier of the at least one CPAC candidate cell.

(4) A conditional reconfiguration for the at least one CPAC candidate cell.

In the embodiment of the configuration method 4, the conditional handover message includes conditional reconfiguration information of the CHO candidate cell, and the conditional reconfiguration information includes at least one of the following CPAC information:
(1) the execution condition for the at least one CPAC candidate cell;
(2) the conditional reconfiguration identifier of the at least one CPAC candidate cell; and
(3) CPAC indication information, where the CPAC indication information indicates that the configuration for the CHO candidate cell has an accompanying conditional reconfiguration for CPAC, or indicates that the RRC reconfiguration information of the CHO candidate cell includes the conditional reconfiguration for the at least one CPAC candidate cell.

In the embodiment of the configuration method 4, the method further includes: The terminal executes at least one of the following:

(1) In a case that the RRC reconfiguration information of the CHO candidate cell includes the conditional reconfiguration for the at least one CPAC candidate cell, store the conditional reconfiguration for the at least one CPAC candidate cell into a conditional reconfiguration variable.

(2) In a case that the RRC reconfiguration information of the CHO candidate cell includes the conditional reconfiguration for the at least one CPAC candidate cell, store a measurement configuration for a candidate primary cell, a measurement configuration for a candidate primary secondary cell, or measurement configuration information related to the at least one CPAC candidate cell into a measurement configuration variable.

(3) Perform measurement based on the measurement configuration in the RRC reconfiguration information of the CHO candidate cell. That is, the terminal performs measurement configured in the RRC reconfiguration information of the CHO candidate cell.

(4) In a case that the RRC reconfiguration information of the CHO candidate cell includes the conditional reconfiguration for the at least one CPAC candidate cell, perform, based on the RRC reconfiguration information of the CHO candidate cell, measurement related to the conditional reconfiguration for the at least one CPAC candidate cell. That is, the terminal performs measurement related to a conditional reconfiguration for CPAC in the RRC reconfiguration information of the CHO candidate cell.

In the embodiment of the configuration method 4, in a case that a target primary secondary cell is configured for the CHO candidate cell, the method further includes at least one of the following:

(1) In a case that an execution condition for one or more CPAC candidate cells in the at least one CPAC candidate cell is fulfilled, the terminal uses a second CPAC candidate cell in the one or more CPAC candidate cells as a target primary secondary cell.

(2) In a case that the execution condition for each of the at least one CPAC candidate cell is not fulfilled, the terminal uses the target primary secondary cell configured for the CHO candidate cell.

In some embodiments, for the embodiment of the configuration method 2, the configuration method 2a, the configuration method 3, or the configuration method 4, at least one CPAC candidate cell is associated with a CHO candidate cell in at least one of the following:

(1) An execution condition for the at least one CPAC candidate cell is included in a conditional reconfiguration information element of the CHO candidate cell.

(2) A conditional reconfiguration information element of the at least one CPAC candidate cell is included in the conditional reconfiguration information element of the CHO candidate cell.

(3) A conditional reconfiguration identifier of the at least one CPAC candidate cell is included in the conditional reconfiguration information element of the CHO candidate cell.

(4) A conditional reconfiguration for the at least one CPAC candidate cell includes information about the CHO candidate cell. The information about the CHO candidate cell includes at least one of the following: a cell identifier; a frequency; and a conditional reconfiguration identifier.

In some embodiments, for the embodiment of the configuration method 1, the configuration method 2, the configuration method 2a, the configuration method 3, or the configuration method 4, the method further includes: In a case that execution conditions of multiple CPAC candidate cells in the at least one CPAC candidate cell are fulfilled and the multiple CPAC candidate cells include a source primary secondary cell of the terminal, the terminal uses the source primary secondary cell as a target primary secondary cell for conditional handover. That is, the terminal preferentially selects the source primary secondary cell.

In the configuration method 4, the conditional handover message include the CPAC information, to instruct the UE to decode the RRC reconfiguration information of the CHO candidate cell, which is conducive to reducing a size of signaling messages and improving signaling transmission efficiency.

To describe in detail the conditional handover configuration method provided in the embodiments of this application, the following provides descriptions with reference to several specific embodiments.

### Embodiment 1

In this embodiment, a terminal performs measurement based on a source MCG (Source-MCG), and this embodiment includes the following steps:

Step 1: A UE receives a conditional handover message sent by a network side device, for example, an RRC reconfiguration message. MCG configuration information in the conditional handover message includes at least one of the following:
(1) a measurement configuration corresponding to a frequency and/or an execution condition for a CPAC candidate cell, including a measurement identifier; a measurement object, a report configuration, a conditional trigger configuration, and the like, where for example, the measurement configuration is included in an MCG measurement configuration;
(2) an execution condition for one or more CPAC candidate cells;
(3) a conditional reconfiguration identifier of the one or more CPAC candidate cells; and
(4) a conditional reconfiguration for the one or more CPAC candidate cells.

In this embodiment, the measurement identifier (MeasID) indicated by the execution condition for the CPAC candidate cell is a measurement ID in the MCG measurement configuration.

In this embodiment, one or more CPAC candidate cells are associated with a CHO candidate cell, as detailed in the following association methods a to d.

Association method a: An execution condition for the CPAC candidate cell is included in a conditional reconfiguration information element of the CHO candidate cell.

For example, in an implementation, the conditional reconfiguration information element of the CHO candidate cell is represented by CondReconfigToAddMod-r16, the execution condition for the CPAC candidate is represented by cell condExecutionCondCPCInCHOList, and a specific association method is as follows:

| | |
|---|---|
| RRCReconfiguration ::= | SEQUENCE { |
| conditionalReconfiguration-r16 | ConditionalReconfiguration-r16 |
| OPTIONAL, -- Need M | |
| ConditionalReconfiguration-r16 ::= | SEQUENCE { |
| attemptCondReconfig-r16 | ENUMERATED {true} |
| OPTIONAL, -- Cond CHO | |
| condReconfigToRemoveList-r16 | CondReconfigToRemoveList-r16 |
| OPTIONAL, -- Need N | |
| condReconfigToAddModList-r16 | CondReconfigToAddModList-r16 |
| OPTIONAL, -- Need N | |
| ... | |
| } | |

The conditional reconfiguration information element (CondReconfigToAddModList information element) of the CHO candidate cell is as follows:

-- ASN1START

-- TAG-CONDRECONFIGTOADDMODLIST-START

| | |
|---|---|
| CondReconfigToAddModList-r16 | ::= SEQUENCE (SIZE (1.. |

maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |
| OPTIONAL, -- Need M | |
| condRRCReconfig-r16 | OCTET STRING (CONTAINING |
| RRCReconfiguration) | OPTIONAL, -- Cond condReconfigAdd |
| ..., | |
| [[ | |
| condExecutionCondSN-r17 | OCTET STRING (CONTAINING |
| CondReconfigExecCondSN-r17) | OPTIONAL -- Need M |
| ]], | |
| [[ | |
| condExecutionCondCPCInCHOList | SEQUENCE (SIZE (1.. |

maxNrofCondCells-r16)) OF condExecutionCondCPCInCHO OPTIONAL, -- Need M

| | |
|---|---|
| ]], | |
| } | |
| condExecutionCondCPCInCHO ::= | SEQUENCE (SIZE (1..2)) OF MeasId |
| CondReconfigExecCondSN-r17 ::= | SEQUENCE (SIZE (1..2)) OF MeasId |

-- TAG-CONDRECONFIGTOADDMODLIST-STOP

-- ASN1STOP

Conditional reconfiguration information element descriptions of the CHO candidate cell are shown in the following table:

Conditional reconfiguration information element descriptions of the CHO candidate cell (CondReconfigToAddMod field descriptions)

Conditional reconfiguration information element descriptions of the CHO candidate cell
(CondReconfigToAddMod field descriptions)
Conditional reconfiguration information element descriptions of the CHO candidate cell
(CondReconfigToAddMod field descriptions)
condExecutionCondCPCInCHO
An execution condition that needs to be fulfilled in order to trigger execution of a conditional
reconfiguration for CPAC in CHO. When configuring two triggering events for a candidate cell,
a network ensures that both refer to a same measurement object (The execution condition that
needs to be fulfilled in order to trigger the execution of a conditional reconfiguration for CPAC
in CHO. When configuring 2 triggering events (Meas Ids) for a candidate cell, network ensures
that both refer to the same measObject.).
condExecutionCond
An execution condition that needs to be fulfilled in order to trigger execution of a conditional
reconfiguration for CHO, CPA, intra-SN CPC without MN involvement or MN initiated inter-SN
CPC. When configuring two triggering events (Meas ID) for a candidate cell, a network ensures
that both refer to a same measurement object (The execution condition that needs to be fulfilled
in order to trigger the execution of a conditional reconfiguration for CHO, CPA, intra-SN CPC
without MN involvement or MN initiated inter-SN CPC. When configuring 2 triggering events
(Meas Ids) for a candidate cell, network ensures that both refer to the same measObject).
condExecutionCondSN
Contains an execution condition that needs to be fulfilled in order to trigger execution of a
conditional reconfiguration for SN initiated inter-SN CPC. A measurement identifier refers to a
measurement configuration associated with an SCG. When configuring two triggering events
(Meas ID) for a candidate cell, a network ensures that both refer to a same measurement object.
For each conditional reconfiguration ID, the network always configures either a trigger condition
or a trigger condition SN (not both) (Contains execution condition that needs to be fulfilled in
order to trigger the execution of a conditional reconfiguration for SN initiated inter-SN CPC. The
Meas Ids refer to the measConfig associated with the SCG. When configuring 2 triggering events
(Meas Ids) for a candidate cell, network ensures that both refer to the same measObject. For each
condReconfigurationId, the network always configures either triggerCondition or
triggerConditionSN (not both).).
Conditional reconfiguration information element descriptions of the CHO candidate cell
(CondReconfigToAddMod field descriptions)
condRRCReconfig
An RRC reconfiguration message to be applied when a condition is fulfilled. The RRC
reconfiguration message contained in a conditional RRC reconfiguration cannot contain a field
ConditionalReconfication or a field daps Config or a configuration for a target SCG. For each
conditional reconfiguration ID, a network always configures either a trigger condition or a
trigger condition SN (not both) (The RRCReconfiguration message to be applied when the
condition(s) are fulfilled. The RRCReconfiguration message contained in condRRCReconfig
cannot contain the field conditionalReconfiguration or the field daps-Config or the configuration
for target SCG. For each condReconfigurationId, the network always configures either
triggerCondition or triggerConditionSN (not both)).

Association method b: A conditional reconfiguration information element or a conditional reconfiguration identifier of the CPAC candidate cell is included in the conditional reconfiguration information element of the CHO candidate cell.

For example, in an implementation, the conditional reconfiguration information element of the CHO candidate cell is represented by CondReconfigToAddMod-r16, the conditional reconfiguration for the CPAC candidate cell is represented by condRRCReconfigCPACInCHOList, and a specific association method is as follows:

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |
| OPTIONAL, -- Need M | |
| condRRCReconfig-r16 | OCTET STRING (CONTAINING |
| RRCReconfiguration) | OPTIONAL, -- Cond condReconfigAdd |
| ..., | |
| [[ | |
| condExecutionCondSN-r17 | OCTET STRING (CONTAINING |
| CondReconfigExecCondSN-r17) | OPTIONAL -- Need M |
| ]], | |
| [[ | |
| condRRCReconfigCPACInCHOList | SEQUENCE (SIZE (1.. |

maxNrofCondCells-r16)) OF ConditionalReconfiguration-r16, -- Need M

| | |
|---|---|
| ]], | |
| } | |
| CondReconfigExecCondSN-r17 ::= | SEQUENCE (SIZE (1..2)) OF MeasId |

-- TAG-CONDRECONFIGTOADDMODLIST-STOP

-- ASN1STOP

The conditional reconfiguration for the CPAC candidate cell is described as follows:
condRRCReconfigCPACInCHOList
List of a configuration of candidate SpCells to be added or modified for CPAC in CHO (List of the configuration of candidate SpCells to be added or modified for CPAC in CHO)

Association method c: The conditional reconfiguration identifier of the CPAC candidate cell is included in the conditional reconfiguration information element of the CHO candidate cell.

For example, in an implementation, the conditional reconfiguration information element of the CHO candidate cell is represented by CondReconfigToAddMod-r16, the conditional reconfiguration identifier of the CPAC candidate cell is represented by condRRCReconfigIdCPACInCHOList, and a specific association method is as follows:

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |
| OPTIONAL, -- Need M | |
| condRRCReconfig-r16 | OCTET STRING (CONTAINING |
| RRCReconfiguration) | OPTIONAL, -- Cond condReconfigAdd |
| ..., | |
| [[ | |
| condExecutionCondSN-r17 | OCTET STRING (CONTAINING |
| CondReconfigExecCondSN-r17) | OPTIONAL -- Need M |
| ]], | |
| [[ | |
| condRRCReconfigIdCPACInCHOList | SEQUENCE (SIZE (1.. |
| maxNrofCondCells-r16)) OF CondReconfigId-r16, | -- Need M |
| ]], | |
| } | |
| CondReconfigExecCondSN-r17 ::= | SEQUENCE (SIZE (1..2)) OF MeasId |

```
  -- TAG-CONDRECONFIGTOADDMODLIST-STOP
  -- ASN1STOP
```

The conditional reconfiguration identifier of the CPAC candidate cell is described as follows:
condRRCReconfigCPACInCHOList
List of a configuration of candidate SPCells to be added or modified for CPAC in CHO (List of the configuration of candidate SpCells to be added or modified for CPAC in CHO)

Association method d: The conditional reconfiguration for the CPAC candidate cell includes a cell identifier (for example, a physical cell identifier) or a conditional reconfiguration identifier (condreconfigid, Conditional Reconfiguration ID) of a CHO candidate cell associated with the CPAC candidate cell.

For example, in an implementation, the conditional reconfiguration information element of the CPAC candidate cell is represented by CondReconfigToAddMod-r16, the conditional reconfiguration identifier of the CHO candidate cell associated with the CPAC candidate cell is represented by associatedCondReconfigCHO, and a specific association method is as follows:

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |
| OPTIONAL, -- Need M | |
| condRRCReconfig-r16 | OCTET STRING (CONTAINING |
| RRCReconfiguration) | OPTIONAL, -- Cond condReconfigAdd |
| ..., | |
| [[ | |
| condExecutionCondSN-r17 | OCTET STRING (CONTAINING |
| CondReconfigExecCondSN-r17) | OPTIONAL -- Need M |
| ]], | |
| [[ | |
| associatedCondReconfigCHO | CondReconfigId-r16, -- Need M |
| ]], | |
| } | |
| CondReconfigExecCondSN-r17 ::= | SEQUENCE (SIZE (1..2)) OF MeasId |

-- TAG-CONDRECONFIGTOADDMODLIST-STOP

-- ASN1STOP

Step 2: The UE performs CHO and CPAC evaluation.

Step 3: In some embodiments, in a case that an execution condition for CPAC is fulfilled, the UE obtains, according to a conditional reconfiguration identifier for CPAC included in the MCG configuration information, conditional reconfiguration information of a target primary secondary cell corresponding to the conditional reconfiguration identifier for CPAC from RRC reconfiguration information of the CHO candidate cell.

### Embodiment 2

In this embodiment, a terminal performs measurement based on a source SCG (source-SCG), and this embodiment includes the following steps:

Step 1: A UE receives a conditional handover message sent by a network side device, for example, an RRC reconfiguration message, where the conditional handover message includes at least one of the following:
(1) a measurement configuration corresponding to a frequency and/or an execution condition for a CPAC candidate cell, including a measurement identifier; a measurement object, a report configuration, a conditional trigger configuration, and the like, where for example, the measurement configuration is included in an SCG measurement configuration;
(2) an execution condition for one or more CPAC candidate cells;
(3) a conditional reconfiguration identifier of the one or more CPAC candidate cells; and
(4) a conditional reconfiguration for the one or more CPAC candidate cells.

In this embodiment, the measurement identifier indicated by the execution condition for the CPAC candidate cell is a measurement ID in the SCG measurement configuration.

In this embodiment, the CPAC candidate cell is associated with a CHO candidate cell. In an association method, the conditional reconfiguration for the CPAC candidate cell includes a cell identifier (for example, a physical cell identifier) or a conditional reconfiguration identifier (condreconfigid, Conditional Reconfiguration ID) of a CHO candidate cell associated with the CPAC candidate cell.

Step 2: The UE performs CHO and CPAC evaluation.

Step 3: In some embodiments, in a case that an execution condition for CPAC is fulfilled, the UE obtains, according to a conditional reconfiguration identifier for CPAC included in MCG or SCG configuration information, conditional reconfiguration information of a target primary secondary cell corresponding to the conditional reconfiguration identifier for CPAC from RRC reconfiguration information of the CHO candidate cell.

### Embodiment 2a

In this embodiment, a terminal performs measurement based on a source MCG (Source-MCG) and/or a source SCG (source-SCG), and this embodiment includes the following steps:

Step 1: A UE receives a downlink message that is sent by a network side device and that includes a conditional handover-related configuration, for example, an RRC reconfiguration message. The conditional handover-related configuration includes a CPAC-related configuration, including an execution condition for PSCell change or addition and/or conditional RRC reconfiguration information of a target PSCell, and/or the like. For example, the execution condition for PSCell change or addition is used to measure a target frequency, and there is a cell (referred to as a cell A, where there may be multiple cells fulfilling a condition) whose signal measurement fulfills the preset condition, for example, signal quality exceeds a signal quality threshold and continuously reaches a preset time threshold.

The target frequency is also referred to as a measurement object, and is indicated by a measurement ID. For example, a measurement ID corresponding to an F1 frequency is 1.

The measurement object is configured by a serving MCG and/or SCG of the UE, and is indicated by the measurement ID. A measurement ID configured by the MCG and a measurement ID configured by the SCG may be the same. For example, a measurement ID corresponding to the F1 frequency configured by the MCG is 1, and a measurement ID corresponding to an F2 frequency configured by the SCG is 1. Therefore, in the CPAC-related configuration, there is a need to indicate whether the measurement ID indicated by the execution condition is a measurement ID in a serving MCG or SCG measurement configuration. For example, the CPAC information indicates that the measurement ID is the measurement ID in the MCG configuration and is 1, where the measurement ID is associated with the F1 frequency, and the UE performs evaluation based on a cell measurement result of the F1 frequency. The CPAC information indicates that the measurement ID is the measurement ID in the SCG configuration and is 1, where the measurement ID is associated with the F2 frequency, and the UE performs evaluation based on a cell measurement result of the F2 frequency.

Each CPAC candidate cell PSCell is associated with a CHO candidate cell/PCell. The association relationship is indicated by a serving cell to the UE. In some embodiments, the serving cell may implicitly indicate a correspondence between the PSCell and the PCell by indicating a relationship between an SCG corresponding to the PSCell and an MCG corresponding to the PCell.

Step 2: The UE performs measurement on a current serving cell configuration, and simultaneously performs CHO and CPAC evaluation.

Step 3: When a CPAC candidate PSCell and a CHO candidate PCell corresponding to the CPAC candidate PSCell simultaneously fulfill a corresponding execution condition for CPAC/CHO, the UE applies a corresponding target MCG (corresponding to the PCell)/SCG (corresponding to the PSCell) configuration, to perform handover.

Similarly, in some embodiments, an related indication may be extended to a measurement configuration for a target master node (or target master cell group T-MCG) and a measurement configuration for a target secondary node (or target secondary cell group T-SCG). To be specific, a network (NW) indicates a specific node with a measurement configuration to be a measurement configuration associated with the measurement ID indicated by the execution condition in a UE CPAC-related configuration. A potential measurement configuration node includes one or more of the following: a source (Source) or serving (Serving) MCG; a source or serving SCG; a target (Target) MCG; and a target SCG.

### Embodiment 3

In this embodiment, a terminal performs measurement based on a target MCG (Target-MCG), the terminal decodes CHO reconfiguration information in advance, and this embodiment includes the following steps:

Step 1: A UE receives a conditional handover message sent by a network side device, for example, an RRC reconfiguration message.

MCG configuration information included in RRC reconfiguration information of a CHO candidate cell in the conditional handover message includes at least one of the following:
(1) a measurement configuration corresponding to a frequency and/or an execution condition for a CPAC candidate cell, including a measurement identifier; a measurement object, a report configuration, a conditional trigger configuration, and the like, where for example, the measurement configuration is included in a target MCG measurement configuration in the RRC reconfiguration information of the CHO candidate cell;
(2) an execution condition for one or more CPAC candidate cells; and
(3) a conditional reconfiguration for the one or more CPAC candidate cells.

In this embodiment, the measurement identifier indicated by the execution condition for the CPAC candidate cell is a measurement ID in the target MCG measurement configuration for the CHO candidate cell.

Step 2: After the UE receives the conditional handover message sent by the network side device, the UE decodes the RRC reconfiguration information of the CHO candidate cell in the conditional handover message.

Step 3: In a case that the RRC reconfiguration information of the CHO candidate cell includes information about a conditional reconfiguration for CPAC, the UE stores the conditional reconfiguration for CPAC into a conditional reconfiguration variable, and stores a measurement configuration for a candidate primary cell or a candidate primary secondary cell, or CPAC-related measurement configuration information into a measurement configuration variable.

Step 4: The UE performs measurement configured in the RRC reconfiguration information of the CHO candidate cell. In some embodiments, further, the UE performs measurement related to the conditional reconfiguration for CPAC in the RRC reconfiguration information of the CHO candidate cell.

Step 5: The UE performs CHO and CPAC evaluation.

### Embodiment 4

In this embodiment, a terminal performs measurement based on a target MCG (Target-MCG), this embodiment includes a CPAC indication, and this embodiment includes the following steps:

Step 1: A UE receives a conditional handover message sent by a network side device, for example, an RRC reconfiguration message.

Conditional reconfiguration information of a CHO candidate cell in the conditional handover message includes at least one of the following CPAC information:
(1) an execution condition for one or more CPAC candidate cells;
(2) a conditional reconfiguration identifier of the CPAC candidate cell; and
(3) CPAC indication information, indicating that a configuration for the CHO candidate cell includes at least one CPAC candidate cell.

In this embodiment, a measurement identifier indicated by the execution condition for the CPAC candidate cell is a measurement ID in a target MCG measurement configuration for the CHO candidate cell.

Step 2: In a case that the conditional reconfiguration information of the CHO candidate cell in the conditional handover message received by the UE includes the CPAC information, the UE decodes RRC reconfiguration information of the CHO candidate cell in the conditional handover message.

Step 3: Remaining steps are the same as step 3 to step 5 in Embodiment 3.

### Embodiment 5

In this embodiment, a terminal performs measurement based on a target SCG (target-SCG), and this embodiment includes the following steps:

Step 1: A UE receives a conditional handover message sent by a network side device, for example, an RRC reconfiguration message.

RRC reconfiguration information of a CHO candidate cell in the conditional handover message includes at least one of the following:
(1) a measurement configuration corresponding to a frequency and/or an execution condition for a CPAC candidate cell, including a measurement identifier; a measurement object, a report configuration, a conditional trigger configuration, and the like, where for example, the measurement configuration is included in a target SCG measurement configuration in the RRC reconfiguration information of the CHO candidate cell;
(2) an execution condition for one or more CPAC candidate cells; and
(3) a conditional reconfiguration for the one or more CPAC candidate cells.

In this embodiment, the measurement identifier indicated by the execution condition for the CPAC candidate cell is a measurement ID in the target SCG measurement configuration for the CHO candidate cell.

Step 2: After the UE receives the conditional handover message sent by the network side device, the UE decodes the RRC reconfiguration information of the CHO candidate cell in the conditional handover message.

Step 3: Remaining steps are the same as step 3 to step 5 in Embodiment 3.

### Embodiment 6

In this embodiment, a terminal performs measurement based on a target SCG (target-SCG), this embodiment includes a CPAC indication, and this embodiment includes the following steps:

Step 1: A UE receives a conditional handover message sent by a network side device, for example, an RRC reconfiguration message.

Conditional reconfiguration information of a CHO candidate cell in the conditional handover message includes at least one of the following CPAC information:
(1) an execution condition for one or more CPAC candidate cells;
(2) a conditional reconfiguration identifier of the CPAC candidate cell; and
(3) CPAC indication information, indicating that a configuration for the CHO candidate cell includes at least one CPAC candidate cell.

In this embodiment, a measurement identifier indicated by the execution condition for the CPAC candidate cell is a measurement ID in a target SCG measurement configuration for the CHO candidate cell.

Step 2: In a case that the conditional reconfiguration information of the CHO candidate cell in the conditional handover message received by the UE includes the CPAC information, the UE decodes RRC reconfiguration information of the CHO candidate cell in the conditional handover message.

Step 3: Remaining steps are the same as step 3 to step 5 in Embodiment 3.

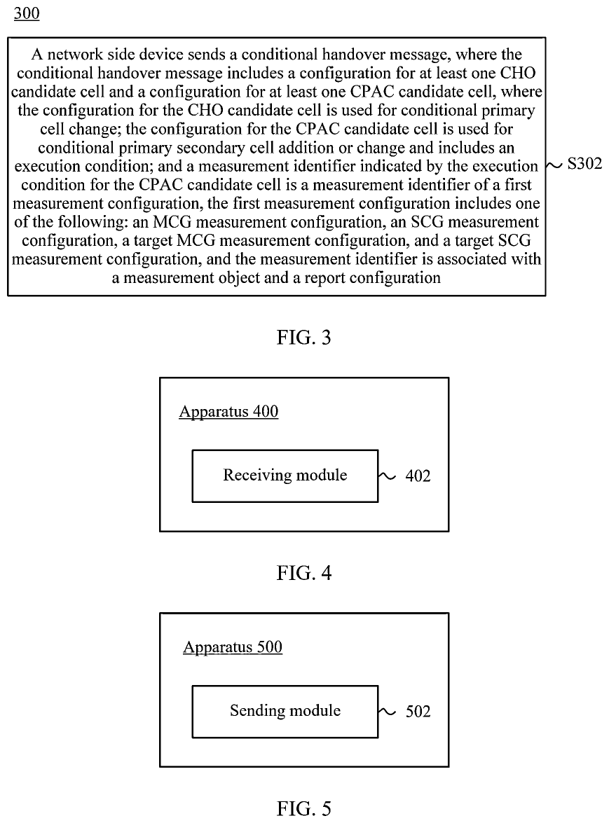

The conditional handover configuration method according to the embodiments of this application is described in detail above with reference to FIG. 2. A conditional handover configuration method according to another embodiment of this application is described in detail below with reference to FIG. 3. It may be understood that interaction between the network side device and the terminal described from the perspective of the network side device is the same as or corresponds to that described on the terminal side in the method shown in FIG. 2. To avoid repetition or, related descriptions are appropriately omitted.

FIG. 3 is a schematic flowchart of an implementation of a conditional handover configuration method according to an embodiment of the present application, where the method may be applied to a network side device. As shown in FIG. 3, a method 300 includes the following step:

S302: The network side device sends a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to the conditional handover configuration method provided in this embodiment of this application, in a process of conditional handover with CPAC, the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help a terminal perform CPAC-related measurement to evaluate the execution condition for the CPAC candidate cell, so that primary secondary cell addition and/or change can be performed in the process of conditional handover, to improve communication system performance.

In some embodiments, in an embodiment, the first measurement configuration includes the MCG measurement configuration, where the conditional handover message includes MCG configuration information, and the MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes SCG configuration information, and the SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes MCG configuration information and SCG configuration information, the MCG configuration information includes at least one of the following: an execution condition for the at least one CPAC candidate cell; a conditional reconfiguration identifier of the at least one CPAC candidate cell; and a conditional reconfiguration for the at least one CPAC candidate cell, and the SCG configuration information includes a measurement configuration corresponding to a frequency and/or the execution condition for the at least one CPAC candidate cell.

In some embodiments, in an embodiment, the first measurement configuration includes the target MCG measurement configuration, where the conditional handover message includes RRC reconfiguration information of the CHO candidate cell, the RRC reconfiguration information of the CHO candidate cell includes target MCG configuration information, and the target MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the target SCG measurement configuration, where the conditional handover message includes RRC reconfiguration information of the CHO candidate cell, the RRC reconfiguration information of the CHO candidate cell includes target SCG configuration information, and the target SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the conditional handover message includes conditional reconfiguration information of the CHO candidate cell, and the conditional reconfiguration information includes at least one of the following CPAC information: (1) the execution condition for the at least one CPAC candidate cell; (2) the conditional reconfiguration identifier of the at least one CPAC candidate cell; and (3) CPAC indication information, where the CPAC indication information indicates that the configuration for the CHO candidate cell includes the at least one CPAC candidate cell.

In some embodiments, in an embodiment, at least one CPAC candidate cell is associated with a CHO candidate cell in at least one of the following: (1) an execution condition for the at least one CPAC candidate cell is included in a conditional reconfiguration information element of the CHO candidate cell; (2) a conditional reconfiguration information element of the at least one CPAC candidate cell is included in the conditional reconfiguration information element of the CHO candidate cell; (3) a conditional reconfiguration identifier of the at least one CPAC candidate cell is included in the conditional reconfiguration information element of the CHO candidate cell; and (4) a conditional reconfiguration for the at least one CPAC candidate cell includes information about the CHO candidate cell.

The conditional handover configuration method provided in the embodiments of this application may be performed by a conditional handover configuration apparatus. In the embodiments of this application, an example in which the conditional handover configuration method is performed by the conditional handover configuration apparatus is used to describe the conditional handover configuration apparatus provided in the embodiments of this application.

FIG. 4 is a schematic diagram of a structure of a conditional handover configuration apparatus according to an embodiment of this application. The apparatus may correspond to a terminal in another embodiment. As shown in FIG. 4, an apparatus 400 includes the following module.

A receiving module 402 is configured to receive a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

In some embodiments, the apparatus 400 may further include a processing module.

According to the conditional handover configuration apparatus provided in this embodiment of this application, in a process of conditional handover with CPAC, the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help evaluate the execution condition for the CPAC candidate cell according to the corresponding measurement configuration, so that primary secondary cell addition and/or change can be performed in the process of conditional handover, to improve communication system performance.

In some embodiments, in an embodiment, the first measurement configuration includes the MCG measurement configuration, where the conditional handover message includes MCG configuration information, and the MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes SCG configuration information, and the SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes MCG configuration information and SCG configuration information, the MCG configuration information includes at least one of the following: an execution condition for the at least one CPAC candidate cell; a conditional reconfiguration identifier of the at least one CPAC candidate cell; and a conditional reconfiguration for the at least one CPAC candidate cell, and the SCG configuration information includes a measurement configuration corresponding to a frequency and/or the execution condition for the at least one CPAC candidate cell.

In some embodiments, in an embodiment, the first measurement configuration includes the target MCG measurement configuration, where the conditional handover message includes RRC reconfiguration information of the CHO candidate cell, the RRC reconfiguration information of the CHO candidate cell includes target MCG configuration information, and the target MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the target SCG measurement configuration, where the conditional handover message includes RRC reconfiguration information of the CHO candidate cell, the RRC reconfiguration information of the CHO candidate cell includes target SCG configuration information, and the target SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the conditional handover message includes conditional reconfiguration information of the CHO candidate cell, and the conditional reconfiguration information includes at least one of the following CPAC information: (1) the execution condition for the at least one CPAC candidate cell; (2) the conditional reconfiguration identifier of the at least one CPAC candidate cell; and (3) CPAC indication information, where the CPAC indication information indicates that the configuration for the CHO candidate cell includes the at least one CPAC candidate cell.

In some embodiments, in an embodiment, at least one CPAC candidate cell is associated with a CHO candidate cell in at least one of the following: (1) an execution condition for the at least one CPAC candidate cell is included in a conditional reconfiguration information element of the CHO candidate cell; (2) a conditional reconfiguration information element of the at least one CPAC candidate cell is included in the conditional reconfiguration information element of the CHO candidate cell; (3) a conditional reconfiguration identifier of the at least one CPAC candidate cell is included in the conditional reconfiguration information element of the CHO candidate cell; and (4) a conditional reconfiguration for the at least one CPAC candidate cell includes information about the CHO candidate cell.

The apparatus 400 according to this embodiment of this application may correspond to the procedures of the method 200 in the embodiments of this application, and units/modules in the apparatus 400 and the foregoing operations and/or functions are separately for implementing the corresponding procedures of the method 200, and can achieve a same or equivalent technical effect. For brevity, details are not described herein again.

The conditional handover configuration apparatus in this embodiment of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), or the like. This is not specifically limited in this embodiment of this application.

FIG. 5 is a schematic diagram of a structure of a conditional handover configuration apparatus according to an embodiment of this application. The apparatus may correspond to a network side device in another embodiment. As shown in FIG. 5, an apparatus 500 includes the following module.

A sending module 502 is configured to send a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

In some embodiments, the apparatus 500 may further include a processing module.

According to the conditional handover configuration apparatus provided in this embodiment of this application, in a process of conditional handover with CPAC, the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help the terminal evaluate the execution condition for the CPAC candidate cell according to the corresponding measurement configuration, so that primary secondary cell addition and/or change can be performed in the process of conditional handover, to improve communication system performance.

In some embodiments, in an embodiment, the first measurement configuration includes the MCG measurement configuration, where the conditional handover message includes MCG configuration information, and the MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes SCG configuration information, and the SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the SCG measurement configuration, where the conditional handover message includes MCG configuration information and SCG configuration information, the MCG configuration information includes at least one of the following: an execution condition for the at least one CPAC candidate cell; a conditional reconfiguration identifier of the at least one CPAC candidate cell; and a conditional reconfiguration for the at least one CPAC candidate cell, and the SCG configuration information includes a measurement configuration corresponding to a frequency and/or the execution condition for the at least one CPAC candidate cell.

In some embodiments, in an embodiment, the first measurement configuration includes the target MCG measurement configuration, where the conditional handover message includes RRC reconfiguration information of the CHO candidate cell, the RRC reconfiguration information of the CHO candidate cell includes target MCG configuration information, and the target MCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the first measurement configuration includes the target SCG measurement configuration, where the conditional handover message includes RRC reconfiguration information of the CHO candidate cell, the RRC reconfiguration information of the CHO candidate cell includes target SCG configuration information, and the target SCG configuration information includes at least one of the following: (1) a measurement configuration corresponding to a frequency and/or an execution condition for the at least one CPAC candidate cell; (2) the execution condition for the at least one CPAC candidate cell; (3) a conditional reconfiguration identifier of the at least one CPAC candidate cell; and (4) a conditional reconfiguration for the at least one CPAC candidate cell.

In some embodiments, in an embodiment, the conditional handover message includes conditional reconfiguration information of the CHO candidate cell, and the conditional reconfiguration information includes at least one of the following CPAC information: (1) the execution condition for the at least one CPAC candidate cell; (2) the conditional reconfiguration identifier of the at least one CPAC candidate cell; and (3) CPAC indication information, where the CPAC indication information indicates that the configuration for the CHO candidate cell includes the at least one CPAC candidate cell.

In some embodiments, in an embodiment, at least one CPAC candidate cell is associated with a CHO candidate cell in at least one of the following: (1) an execution condition for the at least one CPAC candidate cell is included in a conditional reconfiguration information element of the CHO candidate cell; (2) a conditional reconfiguration information element of the at least one CPAC candidate cell is included in the conditional reconfiguration information element of the CHO candidate cell; (3) a conditional reconfiguration identifier of the at least one CPAC candidate cell is included in the conditional reconfiguration information element of the CHO candidate cell; and (4) a conditional reconfiguration for the at least one CPAC candidate cell includes information about the CHO candidate cell.

The apparatus 500 according to this embodiment of this application may correspond to the procedures of the method 300 in the embodiments of this application, and units/modules in the apparatus 500 and the foregoing operations and/or functions are separately for implementing the corresponding procedures of the method 300, and can achieve a same or equivalent technical effect. For brevity, details are not described herein again.

The conditional handover configuration apparatus in this embodiment of this application can implement the processes implemented in the method embodiments in FIG. 2 and FIG. 3, and can achieve a same technical effect. To avoid repetition, details are not described herein again.

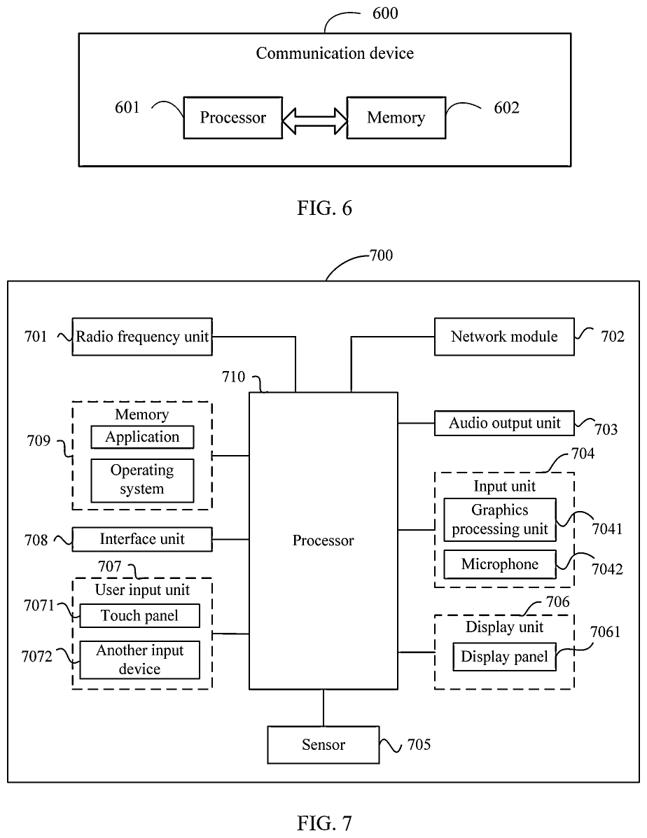

In some embodiments, as shown in FIG. 6, an embodiment of this application further provides a communications device 600, including a processor 601 and a memory 602. The memory 602 stores a program or an instruction that is executable on the processor 601. For example, in a case that the communications device 600 is a terminal, the program or the instruction is executed by the processor 601 to implement the steps of the embodiment of the conditional handover configuration method, and a same technical effect can be achieved. In a case that the communication device 600 is a network side device, the program or the instruction is executed by the processor 601 to implement the steps of the embodiment of the conditional handover configuration method, and a same technical effect can be achieved. To avoid repetition, details are not described herein again.

An embodiment of this application further provides a terminal, including a processor and a communication interface. The communication interface is configured to receive a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration. The terminal embodiment is corresponding to the terminal side method embodiment, each implementation process and implementation of the method embodiment can be applied to the terminal embodiment, and a same technical effect can be achieved. In some embodiments, FIG. 7 is a schematic diagram of a hardware structure of a terminal according to an embodiment of this application.

A terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 through a power supply management system, to implement functions such as charging and discharging management, and power consumption management through the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The GPU 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a nonvolatile memory, or the memory 709 may include both a volatile memory and a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and any memory of another proper type.

The processor 710 may include one or more processing units. In some embodiments, an application processor and a modem processor are integrated into the processor 710. The application processor mainly processes an operating system, a user interface, an application, or the like. The modem processor mainly processes a wireless communication signal, for example, a baseband processor. It may be understood that, in some embodiments, the modem processor may not be integrated into the processor 710.

The radio frequency unit 701 may be configured to receive a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following: an MCG measurement configuration, an SCG measurement configuration, a target MCG measurement configuration, and a target SCG measurement configuration, and the measurement identifier is associated with a measurement object and a report configuration.

According to the terminal provided in this embodiment of this application, in a process of conditional handover with CPAC, the measurement identifier indicated by the execution condition for the CPAC candidate cell is the measurement identifier of the first measurement configuration, and the first measurement configuration includes one of the following: the MCG measurement configuration, the SCG measurement configuration, the target MCG measurement configuration, and the target SCG measurement configuration. This help the terminal evaluate the execution condition for the CPAC candidate cell according to the corresponding measurement configuration, so that primary secondary cell addition and/or change can be performed in the process of conditional handover, to improve communication system performance.

The terminal 700 provided in this embodiment of this application can implement the processes of the forgoing embodiment of the conditional handover configuration method, and can achieve a same technical effect. To avoid repetition, details are not described herein again.

An embodiment of this application further provides a network side device, including a processor and a communication interface. The communication interface is configured to send a conditional handover message, where the conditional handover message includes a configuration for at least one CHO candidate cell and a configuration for at least one CPAC candidate cell, where the configuration for the CHO candidate cell is used for conditional primary cell change; the configuration for the CPAC candidate cell is used for conditional primary secondary cell addition or change and includes an execution condition; and a measurement identifier indicated by the execution condition for the CPAC candidate cell is a measurement identifier of a first measurement configuration, the first measurement configuration includes one of the following:

an MCG measurement configuration, an SCG measurement configuration, a target MCG measurement configuration, and a target SCG measurement configuration, and the measurement identifier is associated with a measurement object and a report configuration. This network side device embodiment is corresponding to the foregoing method embodiment of the network side device. Each implementation process and implementation of the foregoing method embodiment is applicable to the network side device embodiment, and a same technical effect can be achieved.

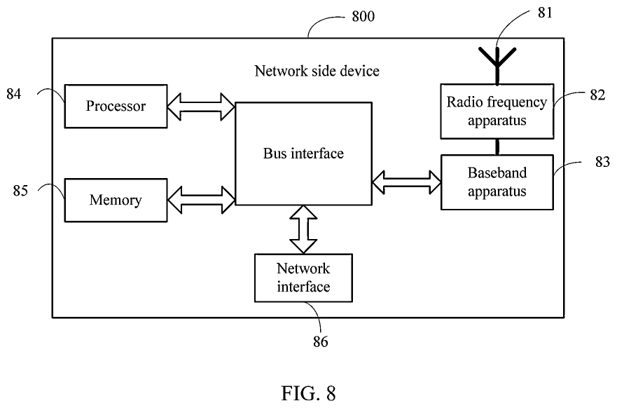

For example, an embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 through a bus interface, to invoke a program in the memory 85 to perform the operations of the network device shown in the foregoing method embodiment.

The network side device may further include a network interface 86, and the interface is, for example, a Common Public Radio Interface (CPRI).

For example, the network side device 800 in this embodiment of the present disclosure further includes an instruction or a program that is stored in the memory 85 and that is executable on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction. The program or the instruction is executed by a processor to implement the processes of the foregoing embodiment of the conditional handover configuration method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the conditional handover configuration method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing embodiment of the conditional handover configuration method, and a same technical effect can be achieved. To avoid repetition, details are not described herein again.

An embodiment of this application further provides a conditional handover configuration system, including a terminal and a network side device. The terminal may be configured to perform the steps of the conditional handover configuration method, and the network side device may be configured to perform the steps of the conditional handover configuration method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A conditional handover configuration method, comprising:
receiving, by a terminal, a conditional handover message, wherein the conditional handover message comprises a configuration for at least one Conditional Handover (CHO) candidate cell and a configuration for at least one Conditional PSCell Addition or Change (CPAC) candidate cell, wherein
the configuration for the CHO candidate cell is used for conditional primary cell change;
the configuration for the CPAC candidate cell is used for conditional primary secondary cell addition or change and comprises an execution condition; and
a measurement identifier indicated by the execution condition for the CPAC candidate cell corresponds to one or more measurement identifiers of a first measurement configuration, the first measurement configuration comprises one of the following: a Master Cell Group (MCG) measurement configuration, a Secondary Cell Group (SCG) measurement configuration, a target MCG measurement configuration, or a target SCG measurement configuration, wherein the measurement identifier is associated with a measurement object and a report configuration.

2. The method according to claim 1, wherein the first measurement configuration comprises the MCG measurement configuration, wherein the conditional handover message comprises MCG configuration information, and the MCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

3. The method according to claim 1, wherein the first measurement configuration comprises the SCG measurement configuration, wherein the conditional handover message comprises SCG configuration information, and the SCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

4. The method according to claim 1, wherein the first measurement configuration comprises the SCG measurement configuration, wherein the conditional handover message comprises MCG configuration information and SCG configuration information,
the MCG configuration information comprises at least one of the following: an execution condition for the at least one CPAC candidate cell; a conditional reconfiguration identifier of the at least one CPAC candidate cell; or a conditional reconfiguration for the at least one CPAC candidate cell, and
the SCG configuration information comprises a measurement configuration corresponding to a frequency or the execution condition for the at least one CPAC candidate cell.

5. The method according to claim 2, further comprising:
when an execution condition for one or more CPAC candidate cells in the at least one CPAC candidate cell is fulfilled, obtaining, by the terminal according to a first conditional reconfiguration identifier of a first CPAC candidate cell in the one or more CPAC candidate cells, conditional reconfiguration information of a target primary secondary cell corresponding to the first conditional reconfiguration identifier from radio resource control RRC reconfiguration information of the CHO candidate cell.

6. The method according to claim 1, wherein the first measurement configuration comprises the target MCG measurement configuration, wherein the conditional handover message comprises RRC reconfiguration information of the CHO candidate cell, the RRC reconfiguration information of the CHO candidate cell comprises target MCG configuration information, and the target MCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

7. The method according to claim 1, wherein the first measurement configuration comprises the target SCG measurement configuration, wherein the conditional handover message comprises Radio Resource Control (RRC) reconfiguration information of the CHO candidate cell, the RRC reconfiguration information of the CHO candidate cell comprises target SCG configuration information, and the target SCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

8. The method according to claim 6, wherein the conditional handover message comprises conditional reconfiguration information of the CHO candidate cell, and the conditional reconfiguration information comprises at least one of the following CPAC information:
the execution condition for the at least one CPAC candidate cell;
the conditional reconfiguration identifier of the at least one CPAC candidate cell; or
CPAC indication information, wherein the CPAC indication information indicates that the configuration for the CHO candidate cell comprises the at least one CPAC candidate cell.

9. The method according to claim 6, further comprising: executing, by the terminal, at least one of the following:
when the RRC reconfiguration information of the CHO candidate cell comprises the conditional reconfiguration for the at least one CPAC candidate cell, storing the conditional reconfiguration for the at least one CPAC candidate cell into a conditional reconfiguration variable;
when the RRC reconfiguration information of the CHO candidate cell comprises the conditional reconfiguration for the at least one CPAC candidate cell, storing a measurement configuration for a candidate primary cell, a measurement configuration for a candidate primary secondary cell, or measurement configuration information related to the at least one CPAC candidate cell into a measurement configuration variable;
performing measurement based on the measurement configuration in the RRC reconfiguration information of the CHO candidate cell; or
when the RRC reconfiguration information of the CHO candidate cell comprises the conditional reconfiguration for the at least one CPAC candidate cell, performing, based on the RRC reconfiguration information of the CHO candidate cell, measurement related to the conditional reconfiguration for the at least one CPAC candidate cell.

10. The method according to claim 6, wherein when a target primary secondary cell is configured for the CHO candidate cell, the method further comprises at least one of the following:
when an execution condition for one or more CPAC candidate cells in the at least one CPAC candidate cell is fulfilled, using, by the terminal, a second CPAC candidate cell in the one or more CPAC candidate cells as a target primary secondary cell; or
when the execution condition for each of the at least one CPAC candidate cell is not fulfilled, using, by the terminal, the target primary secondary cell configured for the CHO candidate cell.

11. The method according to claim 2, wherein the execution condition for the at least one CPAC candidate cell comprises at least one of the following:
the measurement identifier;
the measurement object;
a measurement report configuration;
a conditional trigger configuration; or
a conditional measurement event,
or
wherein the measurement configuration corresponding to the frequency or the execution condition for the at least one CPAC candidate cell comprises at least one of the following:
the measurement identifier;
the measurement object;
a conditional report configuration; or
a conditional trigger configuration.

12. The method according to claim 2, wherein at least one CPAC candidate cell is associated with a CHO candidate cell in at least one of the following:
an execution condition for the at least one CPAC candidate cell is comprised in a conditional reconfiguration information element of the CHO candidate cell;
a conditional reconfiguration information element of the at least one CPAC candidate cell is comprised in the conditional reconfiguration information element of the CHO candidate cell;
a conditional reconfiguration identifier of the at least one CPAC candidate cell is comprised in the conditional reconfiguration information element of the CHO candidate cell; or
a conditional reconfiguration for the at least one CPAC candidate cell comprises information about the CHO candidate cell.

13. The method according to claim 2, further comprising:
when execution conditions of multiple CPAC candidate cells in the at least one CPAC candidate cell are fulfilled and the multiple CPAC candidate cells comprise a source primary secondary cell of the terminal, using, by the terminal, the source primary secondary cell as a target primary secondary cell for conditional handover.

14. A conditional handover configuration method, comprising:
sending, by a network side device, a conditional handover message, wherein the conditional handover message comprises a configuration for at least one Conditional Handover (CHO) candidate cell and a configuration for at least one Conditional PSCell Addition or Change (CPAC) candidate cell, wherein
the configuration for the CHO candidate cell is used for conditional change of a primary cell;
the configuration for the CPAC candidate cell is used for conditional primary secondary cell addition or change and comprises an execution condition; and
a measurement identifier indicated by the execution condition for the CPAC candidate cell is a measurement identifier of a first measurement configuration, the first measurement configuration comprises one of the following: an Master Cell Group (MCG) measurement configuration, a Secondary Cell Group (SCG) measurement configuration, a target MCG measurement configuration, or a target SCG measurement configuration, wherein the measurement identifier is associated with a measurement object and a report configuration.

15. The method according to claim 14, wherein the first measurement configuration comprises the MCG measurement configuration, wherein the conditional handover message comprises MCG configuration information, and the MCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

16. The method according to claim 14, wherein the first measurement configuration comprises the SCG measurement configuration, wherein the conditional handover message comprises SCG configuration information, and the SCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

17. The method according to claim 14, wherein the first measurement configuration comprises the SCG measurement configuration, wherein the conditional handover message comprises MCG configuration information and SCG configuration information,
the MCG configuration information comprises at least one of the following: an execution condition for the at least one CPAC candidate cell; a conditional reconfiguration identifier of the at least one CPAC candidate cell; or a conditional reconfiguration for the at least one CPAC candidate cell, and
the SCG configuration information comprises a measurement configuration corresponding to a frequency or the execution condition for the at least one CPAC candidate cell.

18. The method according to claim 14, wherein the first measurement configuration comprises the target MCG measurement configuration, wherein the conditional handover message comprises RRC reconfiguration information of the CHO candidate cell, the RRC reconfiguration information of the CHO candidate cell comprises target MCG configuration information, and the target MCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

19. The method according to claim 14, wherein the first measurement configuration comprises the target SCG measurement configuration, wherein the conditional handover message comprises Radio Resource Control (RRC) reconfiguration information of the CHO candidate cell, the RRC reconfiguration information of the CHO candidate cell comprises target SCG configuration information, and the target SCG configuration information comprises at least one of the following:
a measurement configuration corresponding to a frequency or an execution condition for the at least one CPAC candidate cell;
the execution condition for the at least one CPAC candidate cell;
a conditional reconfiguration identifier of the at least one CPAC candidate cell; or
a conditional reconfiguration for the at least one CPAC candidate cell.

20. A terminal, comprising a processor and a memory storing instructions, wherein the instructions, when executed by the processor, cause the processor to perform operations comprising:
receiving a conditional handover message, wherein the conditional handover message comprises a configuration for at least one Conditional Handover (CHO) candidate cell and a configuration for at least one Conditional PSCell Addition or Change (CPAC) candidate cell, wherein
the configuration for the CHO candidate cell is used for conditional primary cell change;
the configuration for the CPAC candidate cell is used for conditional primary secondary cell addition or change and comprises an execution condition; and
a measurement identifier indicated by the execution condition for the CPAC candidate cell corresponds to one or more measurement identifiers of a first measurement configuration, the first measurement configuration comprises one of the following: a Master Cell Group (MCG) measurement configuration, a Secondary Cell Group (SCG) measurement configuration, a target MCG measurement configuration, or a target SCG measurement configuration, wherein the measurement identifier is associated with a measurement object and a report configuration.
